(19) United States
(12) Patent Application Publication
(10) Pub. No.: US 2015/0009083 A1
(43) Pub. Date: Jan. 8, 2015

(54) FEED HORN HAVING DIELECTRIC LAYERS AND ASSEMBLY OF FEED HORN AND RADOME

(71) Applicant: Prime Electronics and Satellitics Incorporation, Chung-Li City (TW)

(72) Inventors: Li-Chun SHIUE, CHUNG-LI CITY (TW); Peng-Chen PAN, CHUNG-LI CITY (TW)

(73) Assignee: PRIME ELECTRONICS AND SATELLITICS INCORPORATION, CHUNG-LI CITY (TW)

(21) Appl. No.: 14/244,205

(22) Filed: Apr. 3, 2014

(30) Foreign Application Priority Data
Apr. 3, 2013 (TW) 102206206
Jul. 5, 2013 (TW) 102212815

(51) Int. Cl. H01Q 13/02

(52) U.S. Cl. CPC H01Q 13/0266
USPC 343/776; 343/786; 343/784

(57) ABSTRACT

A feed horn includes at least a wave guiding unit which has a pipe and two dielectric layers. The pipe has an opening and at least an inner surface extending from the opening to an inside of the pipe. The dielectric layers have a larger dielectric constant than air and are fastened to the inner surface of the pipe in a way that the dielectric layers face each other. As a result, the dielectric layers can improve isolation and directivity of cross polarization waves and co-polarization waves received by the feed horn.

### CROSS-REFERENCE TO RELATED APPLICATIONS

This application claims priorities from Taiwan Patent Application No. 102206206 filed on Apr. 3, 2013 and Taiwan Patent Application No. 102212815 filed on Jul. 5, 2013, the entire contents of which are incorporated herein by reference.

### BACKGROUND OF THE INVENTION

1. Field of the Invention

The present invention relates generally to feed horns and more particularly, to a feed horn having dielectric layers for improving the performance of the feed horn in isolation and directivity, and an assembly of the feed horn and a radome.

2. Description of the Related Art

A feed horn is a component of a signal transmission device, such as a satellite television antenna, for receiving signals of one or a plurality of frequency bands and feeding the signals to a signal processor and then to a client device. Alternatively, the feed horn can be used reversely to send out processed signals of one or a plurality of frequency bands.

Many kinds of feed horns are commercially available and different from each other in shapes and structures. Most of the feed horns are designed especially for increasing isolation and directivity of cross polarization waves and co-polarization waves received by the feed horns. A conventional way to achieve the aforesaid purpose is that the feed horn is provided with side-lobe-reducing corrugations. For example, U.S. Pat. No. 3,413,642 or U.S. Pat. No. 3,754,273 disclosed a feed horn having side-lobe-reducing corrugations at an inner surface of the feed horn, and Taiwan Patent No. 1223469 disclosed a feed horn having side-lobe-reducing corrugations surrounding an opening of the feed horn and extending from an outer surface of the feed horn.

In some cases, such as Taiwan Patent No. 1223467, an opening of the feed horn is covered by a radome. In general, the radome for the feed horn has only functions of water resistance and blocking out foreign objects, and may have a disadvantage of deteriorating the performance of the feed horn in receiving and sending signals. A radome for a high-grade feed horn has a specific design that a surface of the radome is perpendicular to advancing directions of electric waves passing through the feed horn. However, the aforesaid specific design of the radome can improve the performance of the feed horn in receiving and sending signals slightly. To minimize the interference from the radome in electric-waves transmission of the feed horn, the conventional radome for the feed horn is designed to be very thin in its thickness; therefore, the conventional radome is difficult in manufacturing and liable to be damaged.

The inventors of the present invention have applied themselves to develop new types of feed horns and radomes for the feed horns to use different ways from the conventional ways to improve the isolation and the directivity of cross polarization waves and co-polarization waves received by the feed horns so as to enhance the performance of the feed horns.

### SUMMARY OF THE INVENTION

The present invention has been accomplished in view of the above-noted circumstances. It is an objective of the present invention to provide a feed horn which has dielectric layers for improving the performance of the feed horn in isolation and directivity.

To attain the above objective, the present invention provides a feed horn comprising at least a wave guiding unit which has a pipe and two dielectric layers. The pipe has an opening and at least an inner surface extending from the opening to an inside of the pipe. The dielectric layers have a larger dielectric constant than air and are fastened to the inner surface of the pipe in a way that the dielectric layers face each other.

As a result, the dielectric layers will not only increase the phase delay of the electromagnetic waves transmitted by the feed horn so as to increase the isolation of cross polarization waves and co-polarization waves but also increase the directivity of the feed horn. Therefore, the feed horn has better performance than the conventional feed horns.

It is another objective of the present invention to provide an assembly of the aforesaid feed horn and a radome, wherein the radome can be so thick as to be easily manufactured and not easily damaged, enhancing the performance of the feed horn in receiving and sending signals.

To attain the above objective, the present invention provides an assembly of the aforesaid feed horn and a radome covering the feed horn and being passed through by a co-polarization wave and a cross polarization wave substantially perpendicular to the co-polarization wave. The wave guiding unit of the feed horn has a wave guiding space in the pipe. The radome comprises a cover and at least a protrusion and is defined with a plurality of first cross-sections parallel to a first axis and a second axis substantially perpendicular to the first axis, and a plurality of second cross-sections parallel to the first axis and a third axis substantially perpendicular to the first axis and the second axis. The cover has a back surface facing the inside of the feed horn and an exposed front surface. The protrusion has an elliptic protruding portion shaped as a part of a hollow ellipsoid and having a convex surface and a concave surface opposite to the convex surface and facing the wave guiding space of the feed horn. Curves of the convex surface and the concave surface in the first cross-sections are different from curves of the convex surface and the concave surface in the second cross-sections. The convex surface and the concave surface are substantially perpendicular to an advancing direction of the co-polarization wave and un-perpendicular to an advancing direction of the cross polarization wave.

As a result, the interference from the radome in the co-polarization wave is minimized by the feature that the concave surface and the convex surface of the elliptic protruding portion of the radome are substantially perpendicular to the advancing direction of the co-polarization wave. At the same time, the interference in the cross polarization wave is increased by the feature that the concave surface and the convex surface of the radome are substantially un-perpendicular to the advancing direction of the cross polarization wave. Therefore, even if the radome is configured so thick as to be easily manufactured and not easily damaged, the configuration design of the convex surface and the concave surface will cause good isolation to the co-polarization wave and the cross polarization wave so as to enhance the performance of the feed horn in receiving and sending signals.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is an exploded perspective view of a feed horn according to a first preferred embodiment of the present invention;

FIG. 2 is a lateral side view of the feed horn according to the first preferred embodiment of the present invention;

FIGS. 3-4 are respectively E-Plane and H-Plane data diagrams obtained by testing the feed horn according to the first preferred embodiment of the present invention when dielectric layers thereof are removed;

FIGS. 5-6 are respectively E-Plane and H-Plane data diagrams obtained by testing the feed horn according to the first preferred embodiment of the present invention without removing the dielectric layers;

FIG. 7 is a lateral side view of a feed horn according to a second preferred embodiment of the present invention;

FIG. 8 is a lateral side view of a feed horn according to a third preferred embodiment of the present invention;

FIG. 9 is a lateral side view of a feed horn according to a fourth preferred embodiment of the present invention;

FIG. 10 is a lateral side view of a feed horn according to a fifth preferred embodiment of the present invention;

FIG. 11 is an exploded perspective view of a feed horn according to a sixth preferred embodiment of the present invention;

FIG. 12 is an exploded perspective view of a feed horn according to a seventh preferred embodiment of the present invention;

FIG. 13 is an exploded perspective view of a feed horn and a radome according to an eighth preferred embodiment of the present invention;

FIG. 14 is a plane view of the back of the radome according to the eighth preferred embodiment of the present invention;

FIG. 15 is a plane view of the front of the radome according to the eighth preferred embodiment of the present invention;

FIG. 16 is a sectional view taking along the line 16-16 in FIG. 14;

FIG. 17 is a sectional view taking along the line 17-17 in FIG. 14;

FIG. 18 is an exploded perspective view of a feed horn and a radome according to a ninth preferred embodiment of the present invention;

FIG. 19 is a plane view of the front of the radome according to the ninth preferred embodiment of the present invention;

FIG. 20 is a plane view of the back of the radome according to the ninth preferred embodiment of the present invention;

FIG. 21 is a perspective view of a radome for a feed horn according to a tenth preferred embodiment of the present invention; and

FIG. 22 is a sectional view taking along the line 22-22 in FIG. 21.

### DETAILED DESCRIPTION OF THE INVENTION

First of all, it is to be mentioned that same reference numerals used in the following preferred embodiments and the appendix drawings designate same or similar elements throughout the specification for the purpose of concise illustration of the present invention.

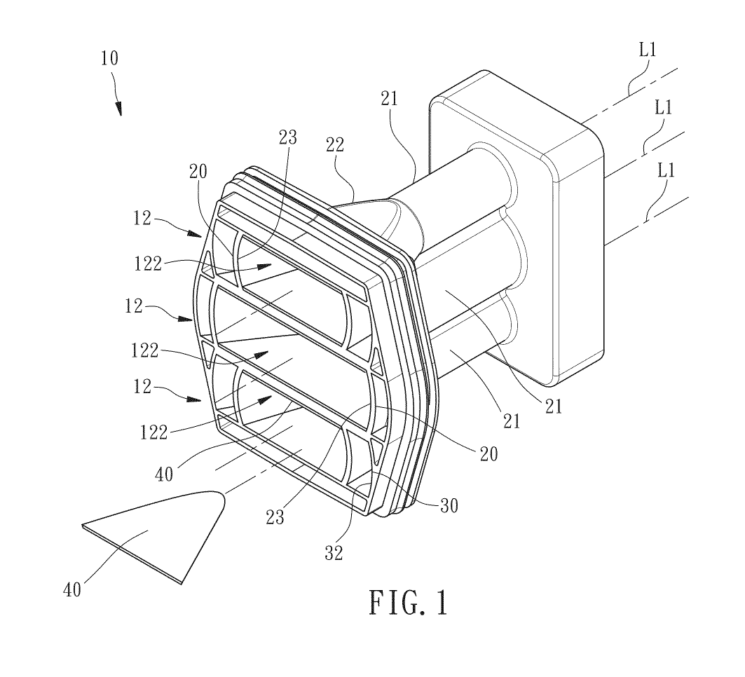

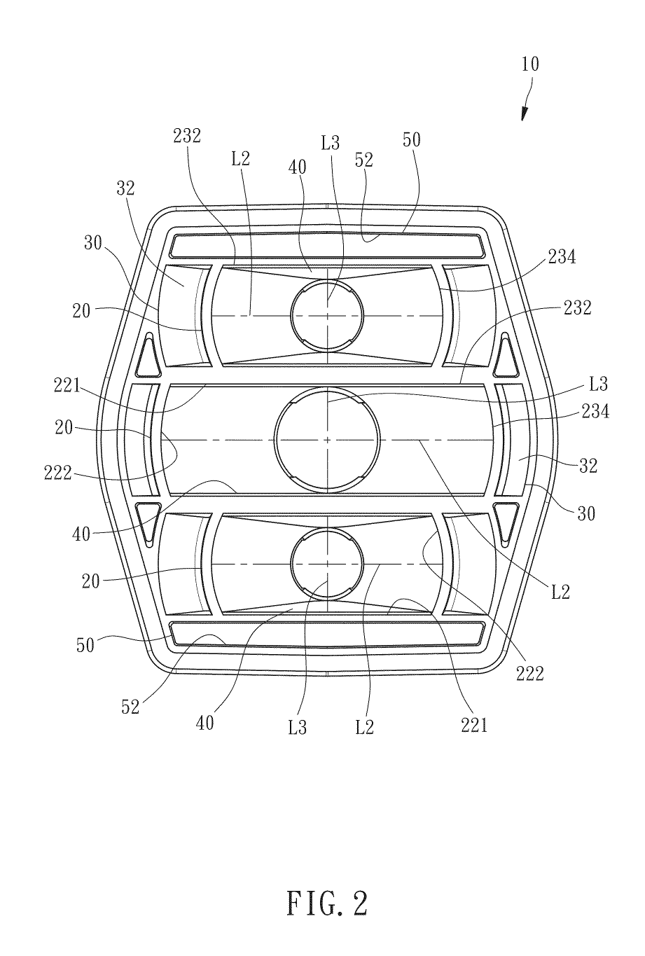

Referring to FIGS. 1-2 wherein FIG. 2 is the front view of enlarged FIG. 1, a feed horn 10 according to a first preferred embodiment of the present invention comprises three wave guiding units 12. Each wave guiding unit 12 has a pipe 20, two tilted side-lobe-reducing corrugations 30, and two dielectric layers 40; in other words, the feed horn 10 in this embodiment has six dielectric layers 40. In FIG. 1, only one of the dielectric layers 40 of one of the wave guiding units 12 is explodedly shown for illustrating the shape of the dielectric layer 40 clearly, and the rest of the dielectric layers 40 are shown in a status of being fixed to the pipes 20.

In the present invention, a single wave guiding unit comprises a wave guiding space for being passed through by signals of a specific frequency band, such as a wave guiding space 122 of the wave guiding unit 12, a main structure for forming the wave guiding space, such as the pipe 20, and two dielectric layers 40 disposed in the wave guiding space. The single wave guiding unit might, but not limited to, further comprise at least a tilted side-lobe-reducing corrugation corresponding to the main structure, such as the tilted side-lobe-reducing corrugation 30. In other words, if a feed horn has two wave guiding spaces, the feed horn has two wave guiding units, and so on.

Each pipe 20 has a first section 21 shaped as a circular pipe, a second section 22 extending from an end of the first section 21 and shaped as a tapered pipe, and an opening 23 located at an end of the second section 22. Each pipe 20 is defined with a central axis L1 substantially passing through the opening 23 perpendicularly. Each opening 23 is elongated like an oblong and therefore defined with a long axis L2 connecting two most distant points of the opening 23 and a short axis L3 substantially perpendicular to the long axis L2. Each opening 23 has two straight long sides 232 located at two ends of the short axis L3 respectively, and two arc short sides 234 located at two ends of the long axis L2 respectively. The second section 22 has two first inner surfaces 221 extending respectively from the long sides 232 to the inside of the pipe 20, and two second inner surfaces 222 extending respectively from the short sides 234 to the inside of the pipe 20. Each of the inner surfaces 221, 222 has a first end located at the opening 23 and a second end opposite to the first end, and extends from the first end to the second end tiltedly and approachingly to the central axis L1. The long axes L2 of the wave guiding units 12 are substantially parallel to each other, and the wave guiding units 12 are aligned along a direction substantially perpendicular to the long axes L2, i.e. parallel to the short axes L3.

In each wave guiding unit 12, the tilted side-lobe-reducing corrugations 30 are integrally connected with the outside of the pipe 20 and located at two ends of the long axis L2, respectively. Each tilted side-lobe-reducing corrugation 30 has an inner surface 32 facing the pipe 20. The inner surface 32 has a first end located by the opening 23 and a second end opposite to the first end and extends from the first end to the second end tiltedly and approachingly to the central axis L1. In this way, the inner surface 32 of each tilted side-lobe-reducing corrugation 30 is tilted to face the opening 23 of the pipe 20 and therefore able to reflect parts of electromagnetic waves passing through the opening 23 to the outside of the opening 23 at a predetermined distance from the opening 23. As a result, the cross polarization waves reflected by the inner surfaces 32 and the cross polarization waves without being reflected will have therebetween a phase difference of about 180 degrees and counteract together for phase offset modulation. Therefore, the side-lobe-reducing corrugations 30 have good performance in reducing side lobes and thereby reducing edge diffraction occurring at the peripheral of the openings 23 so as to increase the isolation of the cross polarization waves and the co-polarization waves.

In this embodiment, two of the wave guiding units 12 of the feed horn 10 each further have a parallel side-lobe-reducing corrugation 50. Each of the parallel side-lobe-reducing corrugations 50 has an inner surface 52 facing the pipe 20 and substantially parallel to the central axis L1 and can also reduce side lobes.

In other words, each of the tilted and parallel side-lobe-reducing corrugations 30, 50 helps increase the isolation of the cross polarization waves and the co-polarization waves received by the feed horn 10. However, the present invention is characterized by the dielectric layers 40 for improving the performance of the feed horn in isolation and directivity, which will be specified in the following paragraphs. Therefore, the feed horn of the present invention is unlimited to have the tilted and parallel side-lobe-reducing corrugations 30, 50.

Each dielectric layer 40 is a sheet made of a material having a larger dielectric constant than air, such as plastic materials including but not limited to polypropylene (PP), alkylbenezenesulfonate (ABS), polyethylene (PE), polycarbonate (PC), and a mixture of ABS and PC, and other materials with low lose in electric waves including but not limited to glass. In each wave guiding unit 12, the dielectric layers 40 are fastened by glue to the first inner surfaces 221 respectively, therefore located at two ends of the short axis L3 respectively and face each other. The feed horn 10 is adapted to receive signal waves having a wavelength symbolized by λ when transmitted in the dielectric layer 40; the thickness of each dielectric layer 40 is optimal to be ranged from 0.005λ to 0.25λ.

Because the dielectric constant of the dielectric layers 40 is larger than air, the dielectric layers 40 will increase the phase delay of the electromagnetic waves transmitted by the feed horn 10 so as to increase the isolation of cross polarization waves and co-polarization waves. Besides, because the dielectric constant of the dielectric layers 40 is larger than air, the ratio of width of the second inner surface 222 to the aforesaid wavelength λ can be increased so as to increase the directivity of the feed horn 10. Therefore, the feed horn with the dielectric layers 40 has better performance in isolation and directivity than the feed horn without the dielectric layers 40.

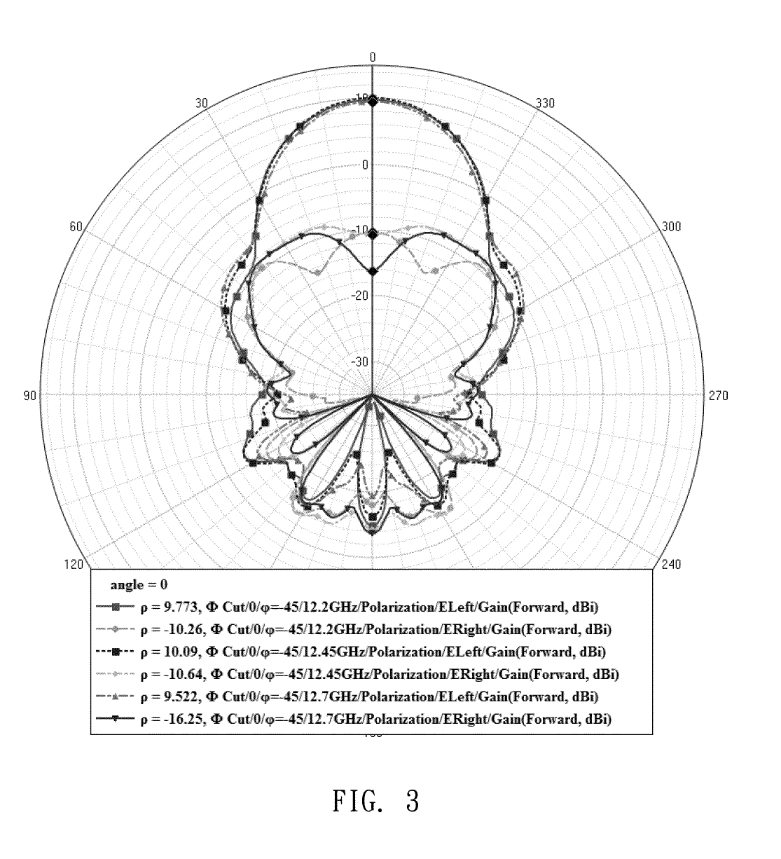

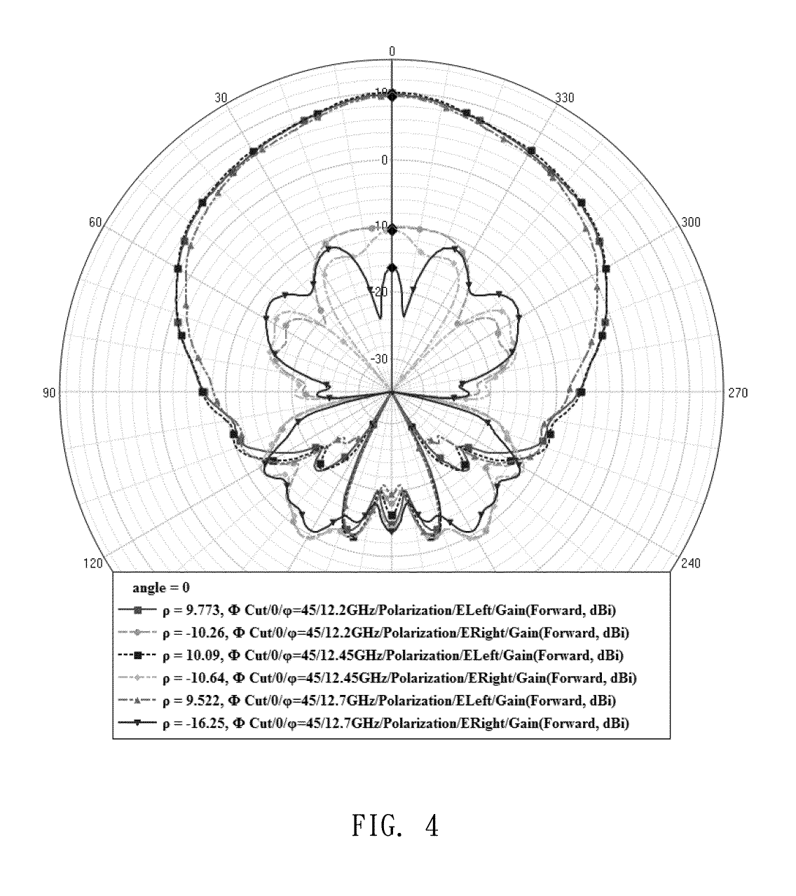

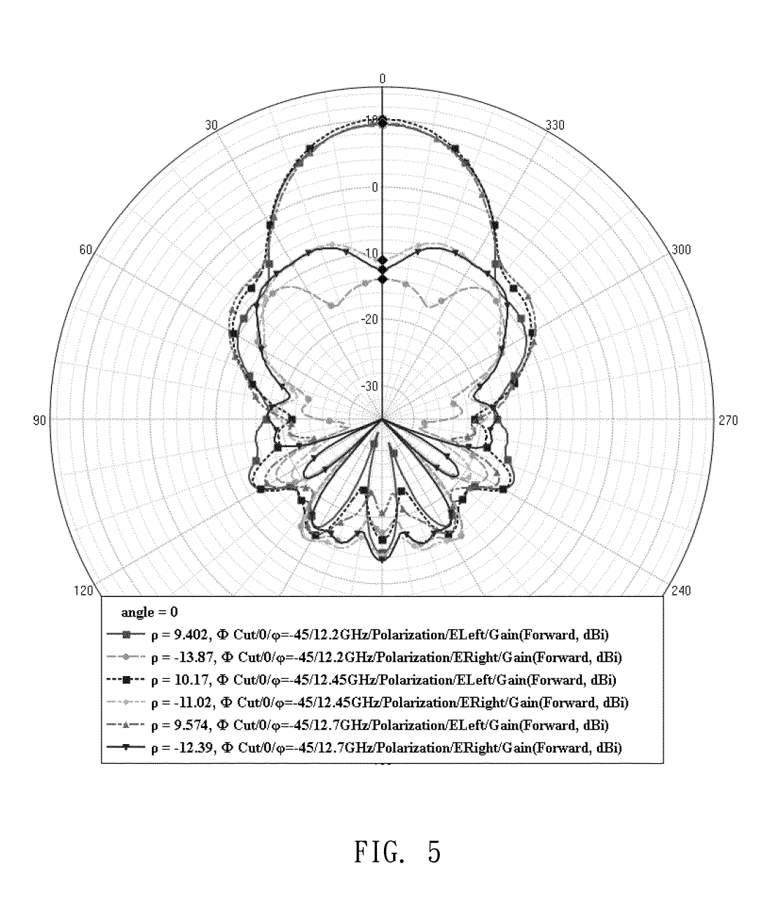

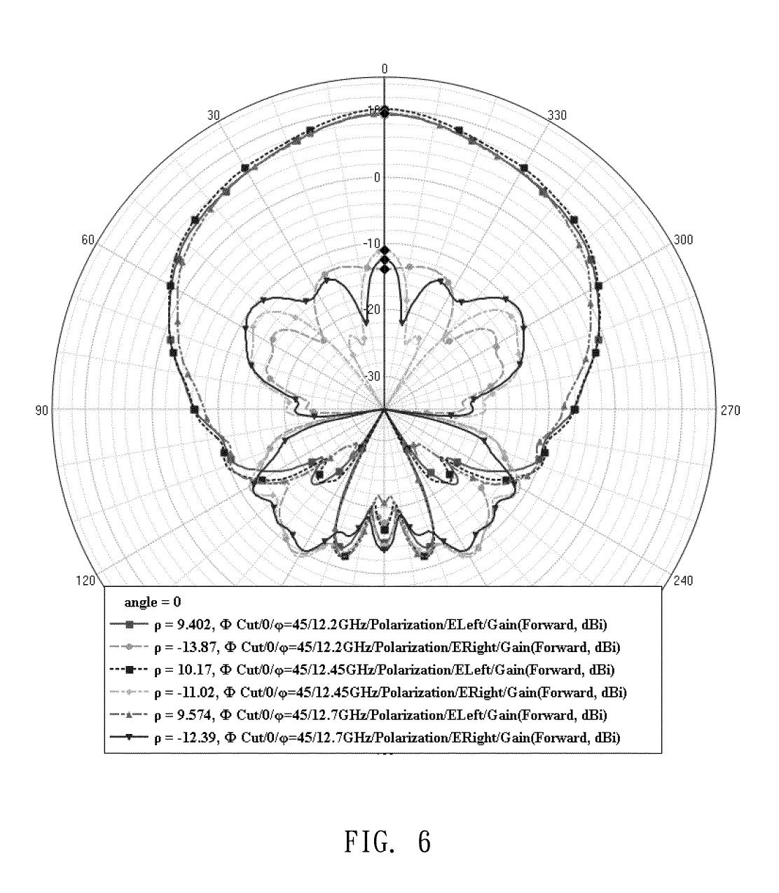

FIGS. 3-4 respectively show the intensity of E-Plane and H-Plane electric waves obtained by testing the aforesaid feed horn 10 when the dielectric layers 40 are removed. FIGS. 5-6 respectively show the intensity of E-Plane and H-Plane electric waves obtained by testing the aforesaid feed horn 10 without removing the dielectric layers 40. It can be observed in FIG. 4 and FIG. 6 that the isolation in H-plane is increased remarkably by the dielectric layers 40. In practice, when the feed horn 10 is installed in a dish antenna and tested, the isolation measured in the condition that the dielectric layers 40 are not removed is larger than the isolation measured in the condition that the dielectric layers 40 are removed by 4 dB, since the dielectric layer can narrow the wave form of the H-plane cross polarization waves.

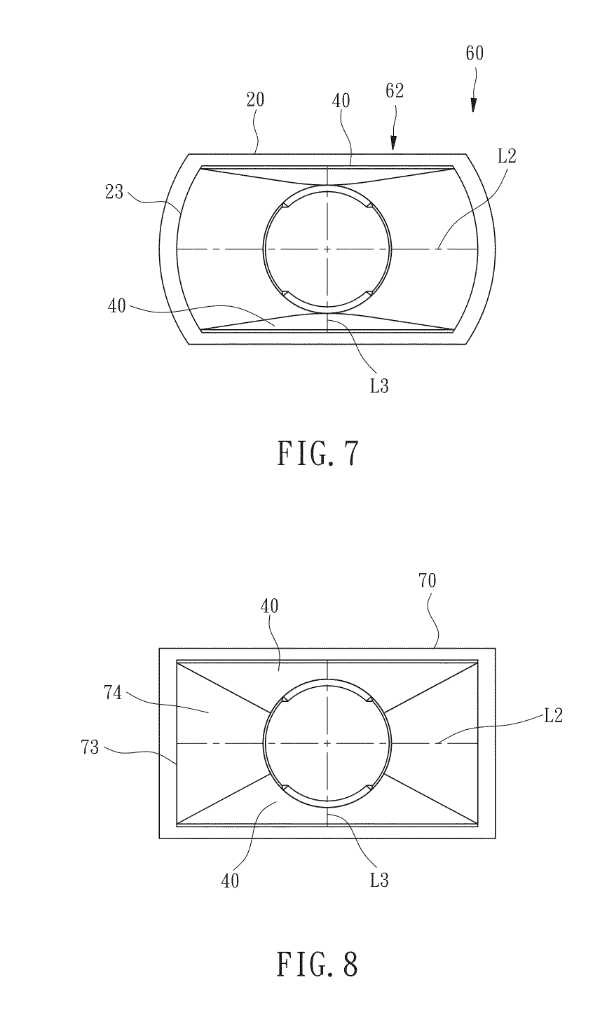

Referring to FIG. 7, a feed horn 60 according to a second preferred embodiment of the present invention comprises only a wave guiding unit 62 which is similar to the aforesaid wave guiding unit 12 but doesn't have any side-lobe-reducing corrugation. The wave guiding unit 62 also has the dielectric layers 40 which improve the performance of the feed horn 60 in isolation and directivity.

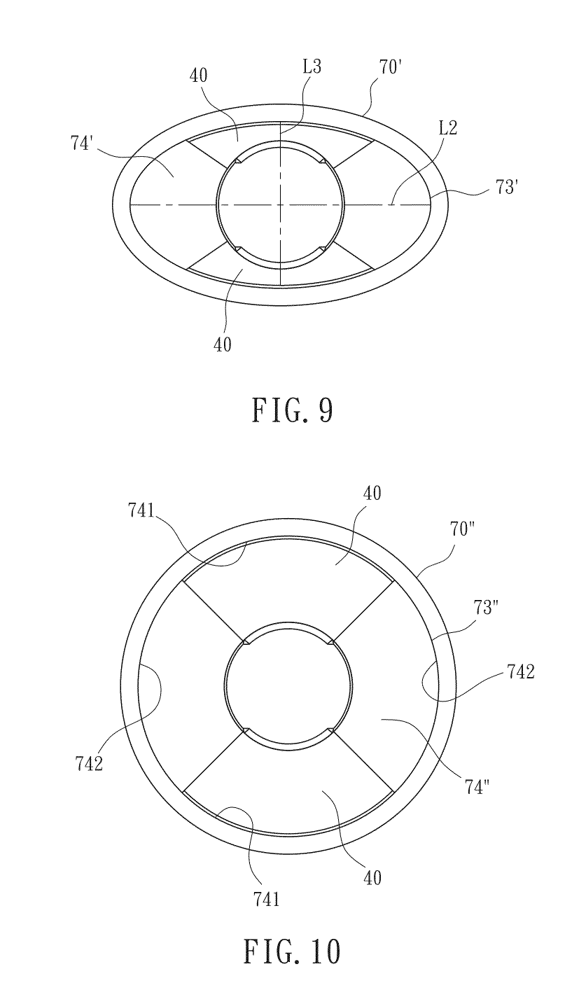

In fact, for the feed horn of the present invention, the amount of the wave guiding unit is unlimited and can be modified according to requirements. Besides, for each wave guiding unit, the shape of the pipe is also unlimited. For example, in a third preferred embodiment of the present invention shown in FIG. 8, the opening 73 of the pipe 70 is shaped as a rectangle; in a fourth preferred embodiment of the present invention shown in FIG. 9, the opening 73′ of the pipe 70′ is shaped as an ellipse. That is, each of the openings 73, 73′ is elongated and defined with a long axis L2 and a short axis L3. Two dielectric layers 40 are fastened to the inner surface 74, 74′ of each pipe 70, 70′ and located at two ends of the short axis L3, respectively.

For the feed horn of the present invention, the opening of the pipe is unlimited to be elongated. For example, in a fifth preferred embodiment of the present invention shown in FIG. 10, the opening 73″ of the pipe 70″ is shaped like a circle. Besides, the inner surface 74″ of the pipe 70″ is defined with two first areas 741 and two second areas 742 by two dielectric layers 40 fastened to the inner surface 74″ and facing each other. The dielectric layers 40 are fixedly located at the first areas 741, and no such dielectric layer 40 is located at the second areas 742. Each of the first and second areas 741, 742 substantially corresponds to a quarter of the opening 73″.

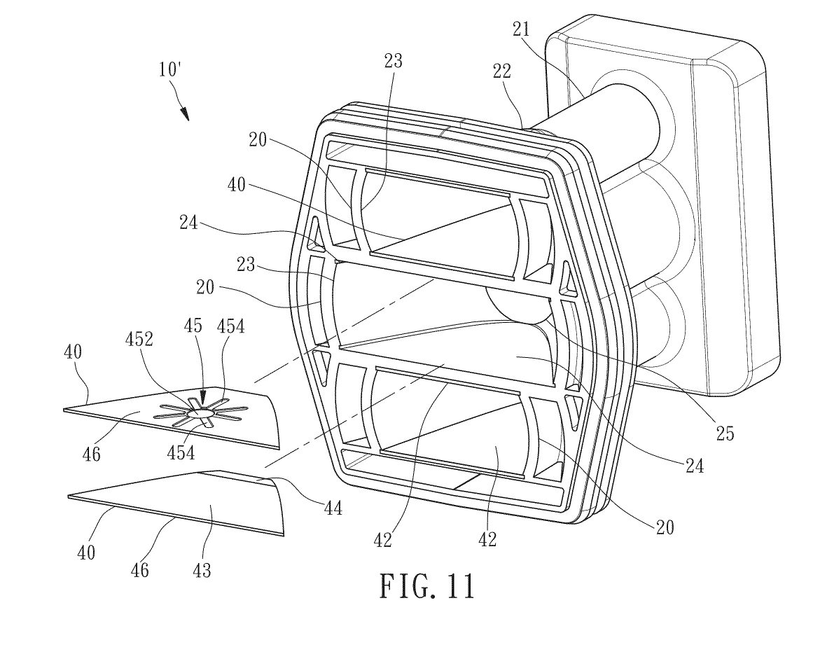

Referring to FIG. 11, a feed horn 10′ according to a sixth preferred embodiment of the present invention is similar to the aforesaid feed horn 10 in the first preferred embodiment. However, in the feed horn 10′, the inner surfaces of each pipe 20 has two concaves 24 and the dielectric layers 40 are embedded and limited in the concaves 24, respectively. This feature can prevent the dielectric layers 40 form being pasted onto the pipe 20 biasedly and make a surface 42 of each dielectric layer 40, which is not fastened to the pipe 20, be flush with the inner surfaces of the pipe 20 so as to prevent each dielectric layer 40 from covering a part of a hole 25 located at the junction of the first and second sections 21, 22 of the pipe 20.

Besides, each dielectric layer 40 of the feed horn 10′ has a first section 43 and a second section 44 thinner than the first section 43 and farther away from the opening 23 of the pipe 20 than the first section 43. The thickness of each dielectric layer 40 concerns the directivity of the feed horn in a way that the thicker the dielectric layer is, the higher the directivity is. If the dielectric layer 40 is uniform in thickness as illustrated in FIG. 1 and required to be very thin for application in low-directivity feed horn, it might be rolled up and therefore difficult to be fastened to the pipe by glue. Since the dielectric layer 40 in this embodiment is not uniform in thickness, it can not only be fastened easily but also maintain the required directivity to the feed horn.

Furthermore, each dielectric layer 40 of the feed horn 10′ has a radial-shaped recess 45 concaved from a connecting surface 46 for being fastened to pipe 20. In this embodiment, the recess 45 comprises a central area 452 and a plurality of guiding areas 454 extending from the central area 452 and shallower than the central area 452. However, the recess 45 is unlimited to be shaped as illustrated in this embodiment. In this way, the glue for fastening the dielectric layer 40 to the pipe 20 can be placed on the central area 452 at first and then spread over the connecting surface 46 by the guiding of the guiding areas 454 when the dielectric layer 40 is pressed on the pipe 20 and the connecting surface 46 is appressed on the inner surface of the pipe 20. As a result, the glue is well-distributed on the connecting surface 46 without spillover from the peripheral of the dielectric layer 40.

The aforesaid features of the feed horn 10′ can also be applied in the aforesaid first to fifth preferred embodiments to make the feed horns having different shapes easier in assembly or better in performance.

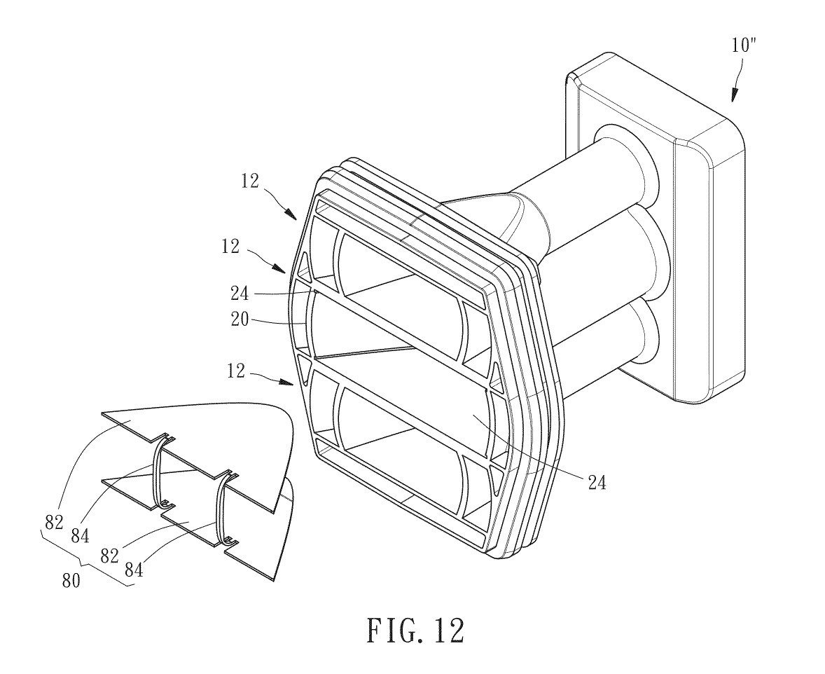

Referring to FIG. 12, a feed horn 10″ according to a seventh preferred embodiment of the present invention is similar to the aforesaid feed horn 10′, but comprises an elastic member 80 having two dielectric layers 82 and two connectors 84 connecting the dielectric layers 82 integrally. The dielectric layers 82 have similar shapes and functions to the aforesaid two dielectric layers 40 in the same wave guiding unit 12. The elastic member 80 is disposed in the pipe 20 in a way that the connectors 84 are bent elastically to provide a rebound force pushing the dielectric layers 82 to the inner surface of the pipe 20. In this way, the dielectric layers 82 can be fastened to the pipe 20 without any glue, and therefore the feed horn 10″ is relatively easier to be assembled. In this embodiment, the inner surface of the pipe 20 can, but not limited to, be provided with two concaves 24 as mentioned before to limit the positions of the dielectric layers 82. In this embodiment, the feed horn 10″ has three wave guiding units 12, and only the wave guiding unit 12 in the middle comprises the elastic member 80. However, the other wave guiding units 12 can also be equipped with the elastic member 80.

In the aforesaid embodiments, each dielectric layer 40 is manufactured as a sheet before installed at the inner surface of the pipe 20. However, each dielectric layer 40 can also be made of a material which is melted and spread on the inner surface of the pipe 20 by coating or injection moulding and then solidified to become the dielectric layer 40.

As mentioned in the previous paragraphs, the feed horn of the present invention is primarily characterized by said two dielectric layers located at the inner surface of each pipe and facing each other, and the dielectric layers can increase the isolation and the directivity of the cross polarization waves and the co-polarization waves received by the feed horn. The characteristics can be applied in feed horns having different shapes. The amount and the arrangement of the wave guiding unit and the shape of the pipe in each wave guiding unit are all unlimited and can be modified according to requirements.

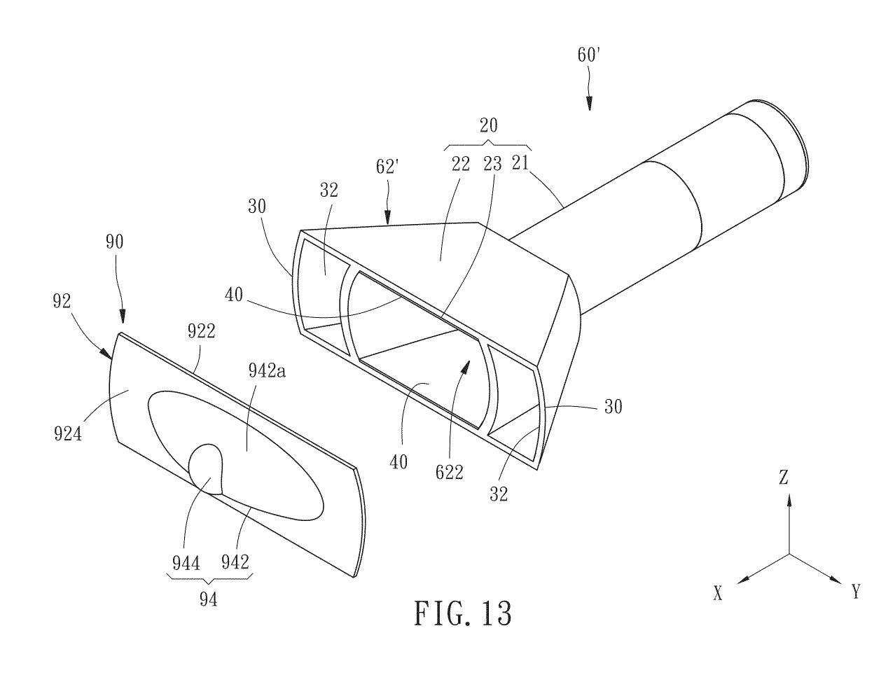

Referring to FIG. 13, an assembly of a feed horn 60′ and a radome 90 covering the feed horn 60′ is provided according to an eighth preferred embodiment of the present invention. The radome 90 can be passed through by a co-polarization wave and a cross polarization wave, which are received or sent out by the feed horn 60′ and advance spirally and perpendicularly to each other at the same time.

The feed horn 60′ is similar to the aforesaid feed horn 60 and comprises a wave guiding unit 62′ having a pipe 20, a wave guiding space 622 in the pipe 20, two dielectric layers 40 fastened to the pipe 20, and two tilted side-lobe-reducing corrugations 30.

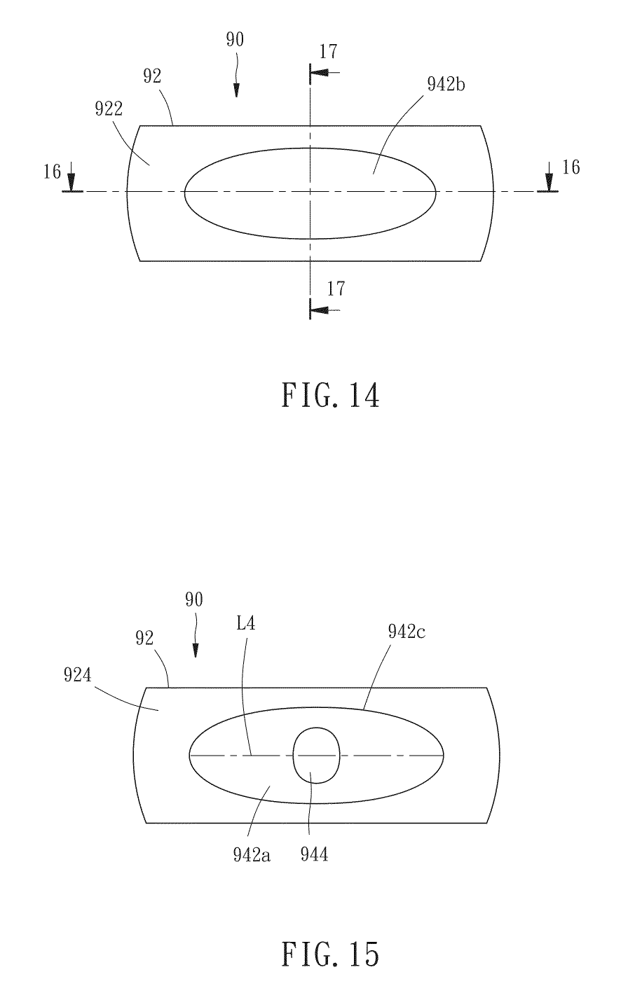

Referring to FIGS. 13-17, the radome 90 comprises a flat cover 92 and a protrusion 94 integrally connected with the cover 92 at the center of the cover 92.

The cover 92 is adapted to be fixed to the feed horn 60′. In this embodiment, the cover 92 and the protrusion 94 are both located out of the wave guiding space 622; however, the cover 92 can be configured to be bent and extend into the wave guiding space 622 so that the protrusion 94 is located in the wave guiding space 622. The cover 92 is provided with a back surface 922 facing an inside of the feed horn 60′ and a front surface 924 exposed outside.

The protrusion 94 has an elliptic protruding portion 942 shaped as a part of a hollow ellipsoid and a spherical protruding portion 944 shaped as a part of a spheroid. The elliptic protruding portion 942 has a convex surface 942a curved outward from the front surface 924 of the cover 92 and a concave surface 942b curved inward from the back surface 922 of the cover 92. The concave surface 942b is a smoothly curved surface facing the wave guiding space 622 of the feed horn 60′. The spherical protruding portion 944 is protruded from the center of the convex surface 942a of the elliptic protruding portion 942.

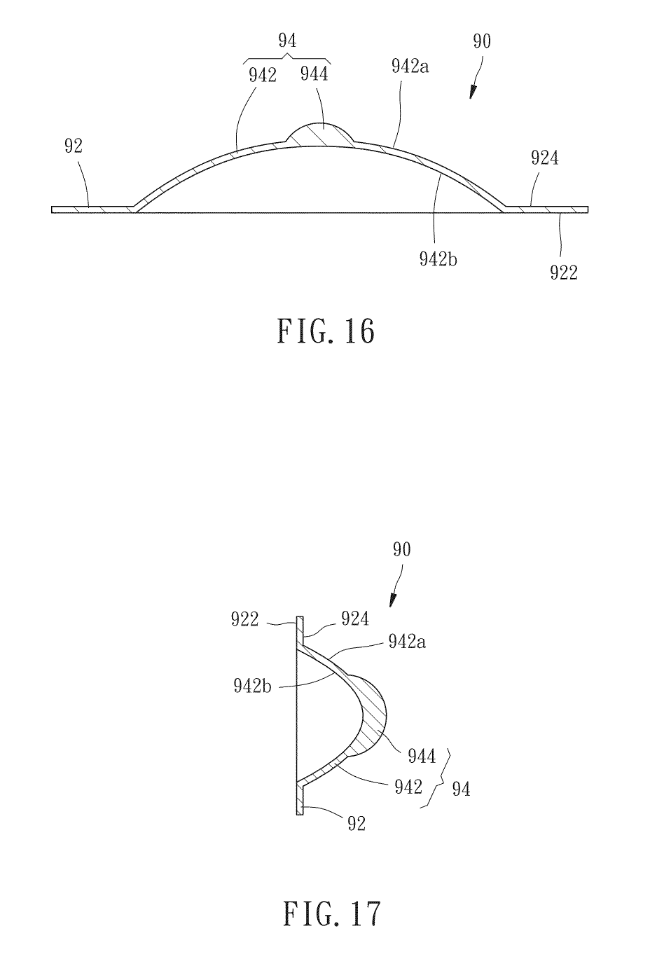

The radome 90 is defined with a plurality of first cross-sections parallel to a first axis (X-axis) and a second axis (Y-axis), such as the cross-section shown in FIG. 16, and a plurality of second cross-sections parallel to the first axis (X-axis) and a third axis (Z-axis), such as the cross-section shown in FIG. 17. The second axis (Y-axis) is substantially perpendicular to the first axis (X-axis), and the third axis (Z-axis) is substantially perpendicular to the first axis (X-axis) and the second axis (Y-axis). As shown in FIG. 16, each curve of the convex surface 942a and the concave surface 942b of the elliptic protruding portion 942 of the protrusion 94 in each of the first cross-sections is a circular arc with a consistent radius of curvature. As shown in FIG. 17, each curve of the convex surface 942a and the concave surface 942b in each of the second cross-sections has a center, two ends and an inconsistent radius of curvature increasing from the center to the ends.

As shown in FIG. 15, the elliptic protruding portion 942 of the radome 90 has an outer contour 942c which is elongated and therefore defined with a long axis L4 connecting two most distant points of the outer contour 942c. The outer contour 942c is elliptic in this embodiment, but not limited to be elliptic. The long axis L4 is parallel to the second axis (Y-axis) and the long axis L2 of the opening 23 of the feed horn 60′.

Because of the specific design of the elliptic protruding portion 942 of the radome 90, the convex surface 942a and the concave surface 942b are substantially perpendicular to the advancing direction of the co-polarization wave so that the interference from the radome 90 in the co-polarization wave is minimized. At the same time, the convex surface 942a and the concave surface 942b are substantially unperpendicular to the advancing direction of the cross polarization wave so that the interference in the cross polarization wave is raised. As a result, even if the radome 90 is configured so thick as to be easily manufactured and not easily damaged, the configuration design of the convex surface 942a and the concave surface 942b will cause high isolation to the co-polarization wave and the cross polarization wave so as to enhance the performance of the feed horn in receiving and sending signals.

Besides, the spherical protruding portion 944 of the radome 90 can also increase the isolation of the co-polarization wave and the cross polarization wave and has the same function of focusing with a convex lens so as to increase the directivity of the electric waves passing through the radome 90. However, the radome 90 can be provided with no such spherical protruding portion 944.

It will be appreciated that the elongated outer contour 942c of the elliptic protruding portion 942 of the radome 90 is configured correspondingly to the opening 23 of the feed horn 60′ so that most of the electric waves passing through the opening 23 will be affected by the elliptic protruding portion 942 and therefore increased in the isolation of the co-polarization wave and the cross polarization wave. However, the shapes of the elliptic protruding portion 942 and the opening 23 of the feed horn 60′ are not limited to the shapes in this embodiment and not limited to be elongated.

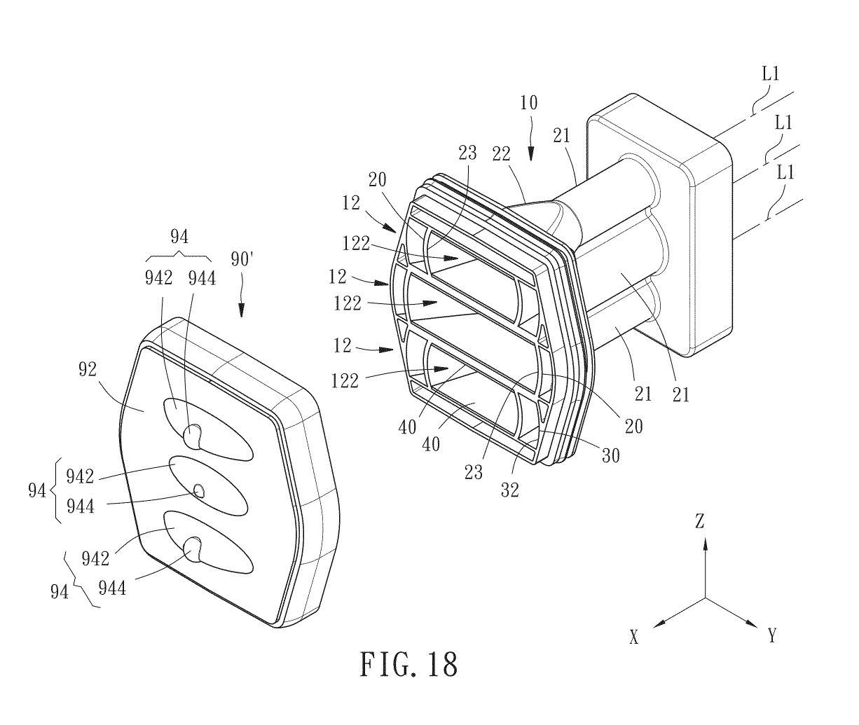

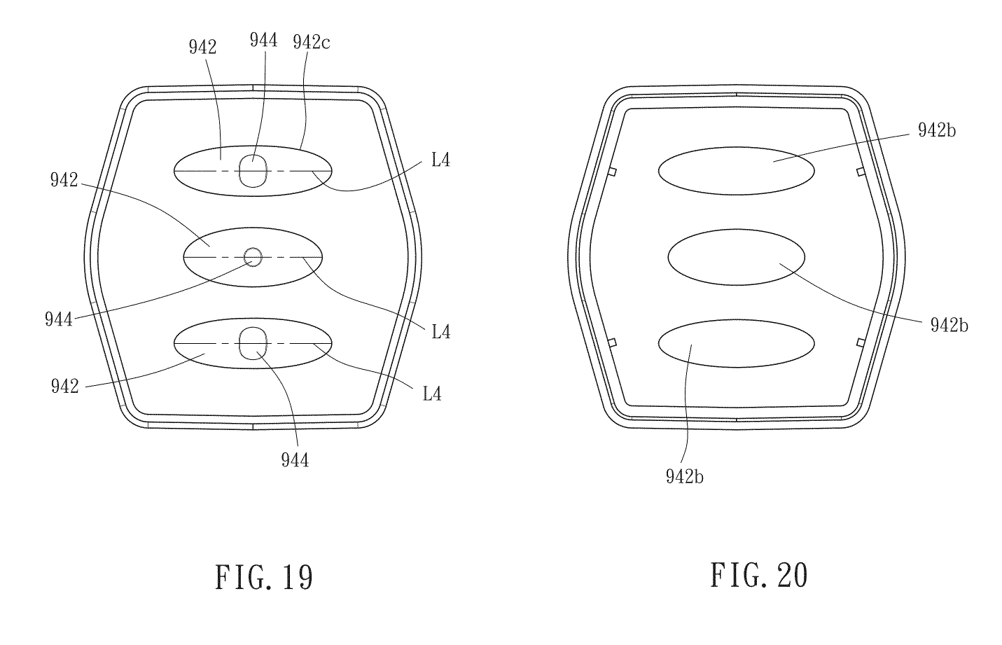

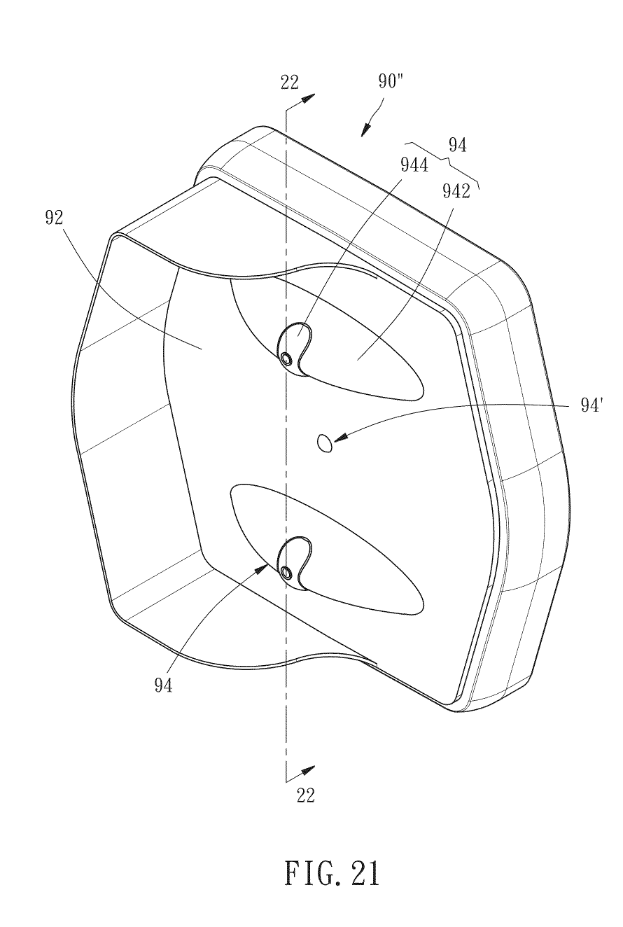

In the present invention, the feed horn may comprise a plurality of wave guiding units; in this event, the radome may comprise a plurality of protrusions. For example, an assembly of a feed horn 10 as mentioned before and a radome 90′ according to a ninth preferred embodiment is shown in FIGS. 18-20, wherein the feed horn 10 comprises three wave guiding units 12 and the radome 90′ comprises a cover 92 as described before and three protrusions 94 integrally connected with the cover 92. The concave surfaces 942b of the elliptic protruding portions 942 of the protrusions 94 face the wave guiding spaces 122 of the wave guiding units 12, respectively. The long axes L4 of the outer contours 942c of the elliptic protruding portions 942 and the long axes L2 of the openings 23 of the wave guiding units 12 are substantially parallel to the second axis (Y-axis). The protrusions 94 are aligned substantially along the third axis (Z-axis). As a result, the protrusions 94 can affect the electric waves passing through the wave guiding spaces 122 respectively and increase the isolation and the directivity of the electric waves.

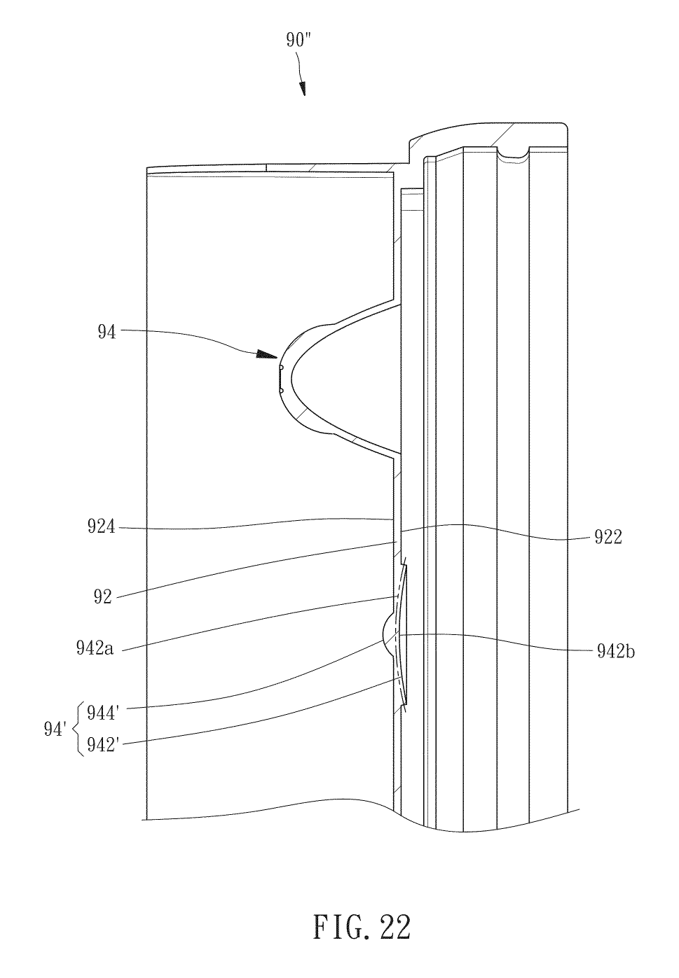

In the present invention, the elliptic protruding portion of the radome for the feed horn is positioned according to the wavefronts of the electric waves received by the wave guiding unit corresponding to the elliptic protruding portion. Therefore, the convex and concave surfaces of the elliptic protruding portion are unlimited to be curved outward and inward from the front and back surfaces of the cover respectively. For example, a radome 90″ according to a tenth preferred embodiment of the present invention and shown in FIGS. 21-22 has two protrusions 94 as mentioned before, and a protrusion 94′ located between the protrusions 94 and going to be more close to the feed horn than the protrusions 94. The elliptic protruding portion 942′ of the protrusion 94′ is overlapped with the cover 92 so that the convex surface 942a of the elliptic protruding portion 942′ is concealed in the cover 92. Besides, the elliptic protruding portion 942′ is partially protruded from the back surface 922 of the cover 92 so that the concave surface 942b of the elliptic protruding portion 942′ is not curved inward from the back surface 922. This kind of protrusion 94′ can also improve the isolation and the directivity of the electric waves received by the feed horn.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A feed horn comprising:
at least a wave guiding unit comprising:
a pipe having an opening and at least an inner surface extending from the opening to an inside of the pipe; and
two dielectric layers having a larger dielectric constant than air and being fastened to the inner surface of the pipe in a way that the dielectric layers face each other.

2. The feed horn as claimed in claim 1, wherein the feed horn is adapted to receive a signal wave having a wavelength λ when the signal wave is transmitted in the dielectric layer; each of the dielectric layers has a thickness ranged from 0.005λ to 0.25λ.

3. The feed horn as claimed in claim 1, wherein the opening of the pipe of the wave guiding unit is elongated and therefore defined with a long axis connecting two most distant points of the opening and a short axis substantially perpendicular to the long axis; the dielectric layers are located at two ends of the short axis, respectively.

4. The feed horn as claimed in claim 3, which comprises a plurality of said wave guiding units, wherein the long axes of the openings of the wave guiding units are substantially parallel to each other; the wave guiding units are aligned along a direction substantially perpendicular to the long axes.

5. The feed horn as claimed in claim 3, wherein the opening of the pipe is shaped as a rectangle or an ellipse.

6. The feed horn as claimed in claim 1, wherein the opening of the pipe of the wave guiding unit has two long sides and two short sides; the pipe has four said inner surfaces including two first inner surfaces extending respectively from the long sides to the inside of the pipe and two second inner surfaces extending respectively from the short sides to the inside of the pipe; the dielectric layers are fastened to the first inner surfaces, respectively.

7. The feed horn as claimed in claim 1, wherein the opening of the pipe is shaped as a circle; the inner surface of the pipe is defined by the dielectric layers with two first areas where the dielectric layers are fixedly located and two second areas where no such dielectric layer is located; each of the first and second areas substantially corresponds to a quarter of the opening.

8. The feed horn as claimed in claim 1, wherein each of the dielectric layers is manufactured as a sheet before disposed at the inner surface of the pipe and has a connecting surface fastened to the inner surface of the pipe and a recess concaved from the connecting surface.

9. The feed horn as claimed in claim 8, wherein the recess of each dielectric layer is radial-shaped.

10. The feed horn as claimed in claim 9, wherein the recess of each dielectric layer comprises a central area and a plurality of guiding areas extending from the central area and shallower than the central area.

11. The feed horn as claimed in claim 1, wherein the inner surface of the pipe has two concaves; the dielectric layers are manufactured as two sheets and then embedded in the concaves, respectively.

12. The feed horn as claimed in claim 1, wherein the dielectric layers are made of a material which is melted and spread on the inner surface of the pipe by coating or injection moulding and then solidified to become the dielectric layers.

13. The feed horn as claimed in claim 1, wherein each of the dielectric layers has a first section and a second section thinner than the first section.

14. The feed horn as claimed in claim 13, wherein the second section of each dielectric layer is farther away from the opening of the pipe than the first section.

15. The feed horn as claimed in claim 1, wherein the wave guiding unit comprises an elastic member having said two dielectric and a connector connecting the dielectric layers and bent elastically to provide a rebound force to fasten the dielectric layers to the inner surface of the pipe.

16. An assembly comprising the feed horn of claim 1 and a radome covering the feed horn and being passed through by a co-polarization wave and a cross polarization wave substantially perpendicular to the co-polarization wave; wherein the wave guiding unit of the feed horn has a wave guiding space in the pipe; the radome comprises a cover and at least a protrusion and is defined with a plurality of first cross-sections parallel to a first axis and a second axis substantially perpendicular to the first axis, and a plurality of second cross-sections parallel to the first axis and a third axis substantially perpendicular to the first axis and the second axis; the cover has a back surface facing the inside of the feed horn and a front surface; the protrusion has an elliptic protruding portion shaped as a part of a hollow ellipsoid and having a convex surface and a concave surface opposite to the convex surface and facing the wave guiding space of the feed horn; curves of the convex surface and the concave surface in the first cross-sections are different from curves of the convex surface and the concave surface in the second cross-sections; the convex surface and the concave surface are substantially perpendicular to an advancing direction of the co-polarization wave and un-perpendicular to an advancing direction of the cross polarization wave.

17. The assembly as claimed in claim 16, wherein the convex surface is curved outward from the front surface of the cover; the concave surface is curved inward from the back surface of the cover.

18. The assembly as claimed in claim 16, wherein each of the curves of the convex surface and the concave surface of the elliptic protruding portion of the protrusion in each of the first cross-sections is a circular arc with a consistent radius of curvature; each of the curves of the convex surface and the concave surface in each of the second cross-sections has a center, two ends and an inconsistent radius of curvature increasing from the center to the ends.

19. The assembly as claimed in claim 16, wherein the protrusion of the radome further has a spherical protruding portion protruded from the convex surface of the elliptic protruding portion and shaped as a part of a spheroid.

20. The assembly as claimed in claim 16, wherein the elliptic protruding portion of the radome has an outer contour which is elongated and therefore defined with a long axis connecting two most distant points of the outer contour and parallel to the second axis.
